(19) United States
(12) Patent Application Publication
(10) Pub. No.: US 2021/0070008 A1
(43) Pub. Date: Mar. 11, 2021

(54) PROTECTIVE FILM AND METHOD OF USE THEREOF

(71) Applicant: 3M INNOVATIVE PROPERTIES COMPANY, St. Paul, MN (US)

(72) Inventors: Jon P. Nietfeld, Woodbury, MN (US); Adam J. Meuler, Woodbury, MN (US); Moses M. David, Wells, TX (US); Richard J. Pokorny, Maplewood, MN (US); Paul B. Armstrong, St. Paul, MN (US); Jun Ma, Woodbury, MN (US); Molly J. Smith, Hudson, WI (US); Haeen Sykora, Hudson, WI (US); Chad M. Amb, Roberts, WI (US)

(21) Appl. No.: 16/960,272

(22) PCT Filed: Jan. 8, 2019
(86) PCT No.: PCT/US2019/012677

§ 371 Date: Jul. 6, 2020

Related U.S. Application Data
(60) Provisional application No. 62/741,775, filed on Oct. 5, 2018.
(60) Provisional application No. 62/614,846, filed on Jan. 8, 2018.

(51) Int. Cl. B32B 3/30; C09J 7/29; B32B 7/12; B32B 27/08; B32B 27/40; B60J 1/20; B60J 1/02; B60R 11/04

(52) U.S. Cl. CPC B32B 3/30; C09J 7/29; B32B 7/12; B32B 27/08; C08K 9/06; B60J 1/2094; B60J 1/02; B60R 11/04; B32B 27/40

(57) ABSTRACT

A vehicle sensor system comprising an exterior surface and a polymeric film on the exterior surface. The polymeric film has a first surface opposite the exterior surface, and the first surface is either hydrophobic or hydrophilic.

### FIELD OF THE INVENTION

The present application relates to polymeric films used to protect a surface, in particular, to such films used to protect surfaces (e.g., a sensor surface) of a vehicle (e.g., an automobile, aircraft, watercraft, etc.) For example, a protective film comprising polyurethane, with a hydrophobic surface or a hydrophilic surface, backed by a pressure sensitive adhesive. The present invention also relates to a vehicle, or a body portion thereof, that is protected by the film as well as a method for making the film.

### BACKGROUND

Vehicle sensor systems are becoming an important part of any modern automobile design, serving many different purposes. These sensor systems help car manufacturers bring models to market that are safer, more fuel efficient and more comfortable to drive. Over time, sensors will also enable greater degrees of vehicle automation.

Multilayer films that include one or more layers of a polymeric materials, e.g. polyurethane material, are known. Some of these films are disclosed in, for example, U.S. Pat. Nos. 6,607,831; 5,405,675; 5,468,532 and 6,383,644 as well as International (PCT) Patent Application No. PCT/EP93/01294 (i.e., Publication No. WO 93/24551). Some of these films have been used in surface protection applications. For example, actual film products that have been used to protect the painted surface of selected automobile body parts include multilayer films, such as PUL 0612, PUL 1212 and PUL 1212DC 3M™ High Performance Protective Films manufactured by 3M Company, St. Paul, Minn. Each of these 3M Company film products includes a thermoplastic polyester polyurethane layer that is backed by a pressure sensitive adhesive (PSA) on one major surface and covered by a water-based polyester polyurethane layer on the opposite major surface. Protective and/or decorative coatings may be applied to the exposed surface of these films and may provide various desirable product attributes, including, but not limited to, chemical resistance, water resistance, solvent resistance, toughness, abrasion resistance and durability.

### SUMMARY

The present application is directed to multilayer protective film technology useful in protection of, for example, a vehicle sensor system.

In a first embodiment, the present disclosure provides a vehicle sensor system comprising an exterior surface and a polymeric film on the exterior surface, wherein the polymeric film has a first surface opposite the exterior surface, and the first surface is hydrophobic. The polymeric film can be a single layer or part of a multilayer film. The polymeric film may comprise polyurethane.

A multilayer film may comprise an adhesive layer that can bond the polymeric film to the exterior surface. The adhesive layer may comprise a pressure sensitive adhesive.

The sensor system may comprise a camera, a laser or LIDAR, a sonar sensor or a radar sensor.

The exterior surface may be a windshield surface, a protective housing surface or a lens surface.

The hydrophobic surface may have an advancing water contact angle of greater than 130°, 140°, 1500 or 160°.

The hydrophobic surface may have a contact angle hysteresis of less than 15°, 10 or 5°.

The polymeric film may have a haze of less than 7 percent and a transmittance of greater than 90%. In instances where the polymeric film is part of a multilayer film, the multilayer film may have a haze of less than 7 percent and a transmittance of greater than 90%.

In a second embodiment, the present disclosure provides a vehicle sensor system comprising an exterior surface and a polymeric film on the exterior surface, wherein the polymeric film has a first surface opposite the exterior surface, and the first surface is hydrophilic. The polymeric film can be a single layer or part of a multilayer film. The polymeric film may comprise polyurethane.

A multilayer film may comprise an adhesive layer that can bond the polymeric film to the exterior surface. The adhesive layer may comprise a pressure sensitive adhesive.

The sensor system may comprise a camera, a laser or LIDAR, a sonar sensor or a radar sensor.

The exterior surface may be a windshield surface, a protective housing surface or a lens surface.

The hydrophobic surface may have an advancing water contact angle of less than 10°, 8° or 5°.

The polymeric film may have a haze of less than 7 percent and a transmittance of greater than 90%. In instances where the polymeric film is part of a multilayer film, the multilayer film may have a haze of less than 7 percent and a transmittance of greater than 90%.

In a third embodiment, the present disclosure provides a method of protecting an exterior surface of a vehicle sensor, comprising applying a polymeric film to the exterior surface, wherein the polymeric film has a first surface, and the first surface is hydrophobic. The polymeric film may comprise a polyurethane film.

In a fourth embodiment, the present disclosure provides a method of protecting an exterior surface of a vehicle sensor, comprising applying a polymeric film to the exterior surface, wherein the polymeric film has a first surface, and the first surface is hydrophilic. The polymeric film may comprise a polyurethane film.

In a fifth embodiment, the present disclosure provides a film comprising a polymeric layer having a hydrophobic nanostructured surface, wherein the surface comprises a silica-containing layer and a layer comprising a fluorinated molecule, and wherein the nanostructured surface has an advancing hexadecane contact angle of greater than 800 or 100°.

In a sixth embodiment, the present disclosure provides a sensor system comprising a sensor, an exterior surface and the film of the fifth embodiment on the exterior surface.

In a seventh embodiment, the present disclosure provides film comprising a polymeric layer having a hydrophobic nanostructured surface, wherein the surface comprises a hydrophobically-modified silica-containing layer.

### DETAILED DESCRIPTION

Although the present invention is herein described in terms of specific embodiments, it will be readily apparent to those skilled in this art that various modifications, re-arrangements, and substitutions can be made without departing from the spirit of the invention.

As used herein, the terms “preferred” and “preferably” refer to embodiments described herein that may afford certain benefits under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

Relative terms such as left, right, top, bottom, side, vertical, and the like may be used herein and, if so, are from the perspective observed in the particular Figure. These terms are used only to simplify the description, however, and not to limit the scope of the invention in any way. Figures are not necessarily to scale.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

### Vehicle Sensor Systems

The use of sensor technology in vehicles has increased. For example, autonomous and semi-autonomous vehicles have the potential to be used in an increasing number of applications. Such autonomous vehicles include at least one vehicle sensor system, a system configured to receive information regarding, for example, the surrounding terrain, upcoming obstacles, a particular path, etc. In some instances, the vehicle sensor system is configured to automatically respond to this information in place of a human operator by commanding a series of maneuvers so that the vehicle is able to negotiate the terrain, avoid the obstacles, or track a particular path with little or no human intervention. Examples of various types of sensors used to detect objects in the surroundings may include lasers or LIDAR (light detection and ranging), sonar, radar, cameras, and other devices which have the ability to scan and record data from the vehicle's surroundings. Such scans will necessarily be initiated or received through an exterior facing element. The exterior facing element may be part of the scanning sensor itself or may be an additional part of the vehicle sensor system that shields or protects more fragile parts. Example of such exterior facing elements include a windshield (if a sensor is placed behind the windshield), a headlight (if sensor is placed behind the headlight), a protective housing and the surface of a camera lens.

The exterior facing element has a surface (the exterior surface) which is exposed to elements, for example temperature, water, other weather, dirt and debris. Any of these elements can interfere with the exterior facing element, and can compromise the scan going out or the data coming in to the vehicle sensor system.

### Polymeric Films

The present application discloses a polymeric film having a first surface. In some embodiments, additional treatments and/or coatings are applied to the first surface. For the purposes of this disclosure, such additional treatments and/or coatings form part of the first surface of the polymeric film. In certain embodiments, the polymeric film is placed on the exterior surface of the exterior facing element and the first surface is opposite the exterior surface. The polymer of the polymeric film is not particularly limited and may be at least one of a thermoplastic, e.g. polyester, polycarbonate, polyurethane, polyalkane (e.g. polyethylene and polypropylene), polysulphone, polyamide, polyacrylate (e.g. polymethylmethacrylate) and polyetheretherketone, and thermoset, e.g. epoxy, phenolic and polyurethane. Blends of various thermoplastics and blends of various thermosets may be used.

The polymeric film may be a polyurethane film. In some embodiments, polyurethane films are preferred because they can be curved and are conformable. Such a layer may comprise a solvent-based or water-based polyurethane, melt processed thermoplastic polyurethane, a crosslinked thermoset polyurethane (e.g. a polyurethane containing siloxane groups) or a UV curable polyurethane (e.g. an acrylate). In some embodiments, the polyurethane is a polyester-based polyurethane, a polycarbonate-based polyurethane or a combination or blend of both. The water-based polyurethane can be made from an aqueous-based polyurethane dispersion (i.e., PUD), and the solvent-based polyurethane can be made from a solvent-based polyurethane solution (i.e., PUS). Typically, the water and solvent, i.e. liquid, is removed from the polyurethane coating solution to form a polyurethane coating or film. Optionally, the polyurethane may be cured during the liquid removal step and/or after liquid removal, enhancing the properties of the polyurethane coating or film.

In certain embodiments, the polymeric film has a first surface that is hydrophilic. Surfaces may be hydrophilic due to the chemical nature of the film. Alternatively, or additionally, surfaces can be made hydrophilic using treatments on the surface or coatings on the surface. See, e.g., PCT Publication Nos. WO2011/084661; WO2011/163175; WO2013/102099; WO2014/036448; US2015/0166935; WO2015/143262; WO2016/044082 and WO2015/164468. In specific embodiments, the films can be processed as disclosed in U.S. Pat. Nos. 5,888,594; 9,340,683; 9,206,335; 9,556,338 and U.S. Publication Nos. 2010/0035039; 2016/0289454 and 2017/0045284, incorporated herein by reference in their entirety, which describes film coated with diamond like glass (DLG) and films coated with DLG and a zwitterionic silane.

Suitable zwitterionic silanes include a zwitterionic sulfonate-functional silane, a zwitterionic carboxylate-functional silane, a zwitterionic phosphate-functional silane, a zwitterionic phosphonic acid-functional silane, a zwitterionic phosphonate-functional silane, or a combination thereof. In certain embodiments, the zwitterionic silane compounds used in the present disclosure have the following Formula (I):

(R¹O)ₚ—Si(Q¹)_{q}-W—N⁺(R²)(R³)—(CH₂)ₘ—Z^{t-} (I)

wherein:

each R¹ is independently a hydrogen, a methyl group, or an ethyl group;

each Q¹ is independently selected from hydroxyl, alkyl groups containing from 1 to 4 carbon atoms, and alkoxy groups containing from 1 to 4 carbon atoms;

each R² and R³ is independently a saturated or unsaturated, straight chain, branched, or cyclic organic group (preferably having 20 carbons or less), which may be joined together, optionally with atoms of the group W, to form a ring;

W is an organic linking group;

Z^{t-} is —SO₃⁻, —CO₂⁻, —OPO₃²⁻, —PO₃²⁻, —OP(═O)(R)O⁻, or a combination thereof, wherein t is 1 or 2, and R is an aliphatic, aromatic, branched, linear, cyclic, or heterocyclic group (preferably R has 20 carbons or less, more preferably R is aliphatic having 20 carbons or less, and even more preferably R is methyl, ethyl, propyl, or butyl);

p and m are integers of 1 to 10 (or 1 to 4, or 1 to 3);

q is 0 or 1; and

p+q=3.

In certain embodiments, the organic linking group W of Formula (I) may be selected from saturated or unsaturated, straight chain, branched, or cyclic organic groups. The linking group W is preferably an alkylene group, which may include carbonyl groups, urethane groups, urea groups, heteroatoms such as oxygen, nitrogen, and sulfur, and combinations thereof. Examples of suitable linking groups W include alkylene groups, cycloalkylene groups, alkyl-substituted cycloalkylene groups, hydroxy-substituted alkylene groups, hydroxy-substituted mono-oxa alkylene groups, divalent hydrocarbon groups having mono-oxa backbone substitution, divalent hydrocarbon groups having mono-thia backbone substitution, divalent hydrocarbon groups having monooxo-thia backbone substitution, divalent hydrocarbon groups having dioxo-thia backbone substitution, arylene groups, arylalkylene groups, alkylarylene groups and substituted alkylarylene groups.

Suitable examples of zwitterionic compounds of Formula (I) are described in U.S. Pat. No. 5,936,703 (Miyazaki et al.) and International Publication Nos. WO 2007/146680 and WO 2009/119690, and include the following zwitterionic functional groups (—W—N⁺(R³)(R⁴)—(CH₂)ₘ—SO₃⁻):

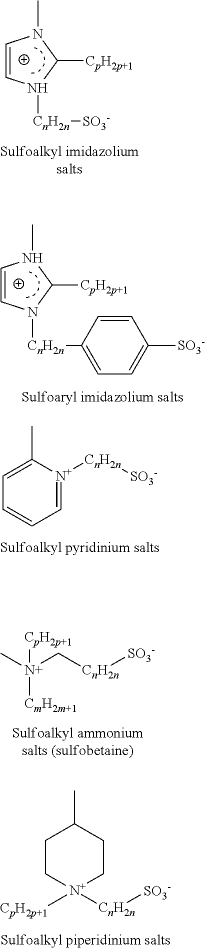

Suitable examples of zwitterionic silanes are described in U.S. Pat. No. 5,936,703 (Miyazaki et al.), including, for example:

(CH₃₀)₃Si—CH₂CH₂CH₂—N⁺(CH₃)₂—CH₂CH₂CH₂—SO₃⁻ and

(CH₃CH₂O)₂Si(CH₃)—CH₂CH₂CH₂—N⁺(CH₃)₂—CH₂CH₂CH₂—SO₃⁻.

Other examples of suitable zwitterionic silanes, which can be made using standard techniques that are exemplified in U.S. Publication No. 2012/0273000 (Jing et al.), include the following:

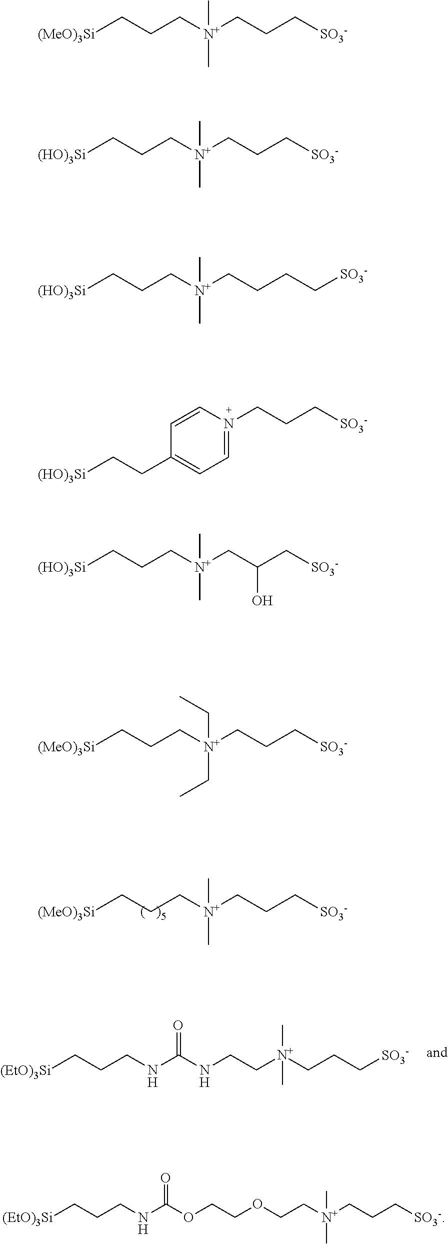

An example of a zwitterionic carboxylate-functional silane compound includes:

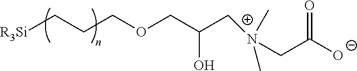

wherein each R is independently OH or alkoxy, and n is an integer of 1 to 10. An example of a zwitterionic phosphate-functional silane compound includes:

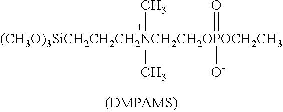

(N,N-dimethyl, N-(2-ethyl phosphate ethyl)-aminopropyl-trimethyoxysilane (DMPAMS)).

An example of a zwitterionic phosphonate-functional silane compound includes:

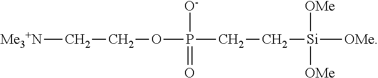

For the purpose of the present application, the definition of a hydrophilic surface is a surface with an advancing water contact angle of less than 15°, for example less than 10°. In some embodiments, the advancing water contact angle is less than 8°, for example less than 5°.

Additional treatments and/or coatings applied to the polymeric film to make the surface additionally hydrophilic, as described herein, are intended to be included in the polymeric film surface.

In certain embodiments, the polymeric film has a first surface that is hydrophobic. Surfaces may be hydrophobic due to the chemical nature of the film. Alternatively, or additionally, surfaces can be made hydrophobic using treatments on the surface, coatings on the surface or, potentially, by incorporating (e.g., melt) additives. For example, the films can be processed as disclosed in U.S. Pat. Nos. 8,974,590; 8,741,158; 7,396,866 and U.S. Publication No. 2012/0107556, incorporated herein by reference in their entirety. Films may also be prepared as disclose in U.S. Pat. No. 5,888,594, incorporated by reference in its entirety, which makes a hydrophilic surface which can be further modified to be made hydrophobic, e.g. with additional coatings, such as a dispersion of hydrophobically modified particles.

In a specific embodiment, the surface is made hydrophobic as defined herein. The surface may be structured, for example using methods disclosed in U.S. Publication No. 2017/0067150, incorporated by reference in its entirety. Such structured surface may then be additionally treated or coated as described above.

For the purpose of the present application, the definition of a hydrophobic surface is a surface with an advancing water contact angle of greater than 125° and a hysteresis of less than 40°. In some embodiments, the advancing water contact angle is greater than 130°, for example greater than 1350 or 140°. In specific embodiments, the advancing water contact angle is greater than 1450 or 150°, for example greater than 1550 or 160°. In some embodiments, the hysteresis is less than 20°, for example less than 15° or less than 100 and in some embodiments less than 5°.

Additional treatments and/or coatings applied to the polymeric film to make the surface additionally hydrophobic, as described herein, are intended to be included in the polymeric film surface. For example, a nanostructured surface can be made using plasma treatment as described, e.g., in U.S. Publication No. 2016/0141149 A1. As used herein, the term “nanostructure” or “nanostructured” refers to an article or surface having at least one nanoscale feature or structure having dimensions in the order of about 10-500 nm. The nanostructured surface made by the method of the disclosure can have a nanostructured anisotropic surface. The nanostructured anisotropic surface typically can comprise nanoscale features having a height to width ratio or about 2:1 or greater; preferably about 5:1 or greater. In some embodiments, the height to width ratio can even be 50:1 or greater, 100:1 or greater, or 200:1 or greater. The nanostructured anisotropic surface can comprise nanofeatures such as, for example, nano-pillars or nano-columns, or continuous nano-walls comprising nano-pillars or nano-columns. Typically, the nanofeatures have steep side walls that are substantially perpendicular to the substrate.

In some embodiments, the majority of the nanofeatures can be capped with mask material. The concentration of the mask material at the surface can be from about 5 weight % to about 90 weight % or from about 10 weight % to about 75 weight %.

In some embodiments, the films are coated with DLG as described above.

Additionally, fluorinated organosilane compounds can be utilized. Fluorinated organosilane compounds that are suitable for use in the invention are described in detail in U.S. Publication No. 2013/0229378 A1, and include those monopodal fluorinated organosilane compounds that comprise (a) a monovalent segment selected from polyfluoroalkyl, polyfluoroether, polyfluoropolyether, and combinations thereof (preferably, polyfluoropolyether) and (b) a monovalent endgroup comprising at least one silyl moiety (preferably, one to about 20; more preferably, one to about 5; most preferably, one or two) comprising at least one group selected from hydrolyzable groups, hydroxyl, and combinations thereof.

Suitable fluorinated organosilane compounds also include those multipodal fluorinated organosilane compounds that comprise (a) a multivalent (preferably, divalent) segment selected from polyfluoroalkane (preferably, polyfluoroalkylene), polyfluoroether, polyfluoropolyether, and combinations thereof (preferably, polyfluoropolyether) and (b) at least two monovalent endgroups, each monovalent endgroup independently comprising at least one silyl moiety (preferably, one to about 20; more preferably, one to about 5; most preferably, one or two) comprising at least one group selected from hydrolyzable groups, hydroxyl, and combinations thereof.

The monopodal and multipodal fluorinated organosilane compounds can be used in combination. When the monovalent and/or multivalent segments of the compounds are fluorinated rather than perfluorinated, preferably not more than one atom of hydrogen is present for every two carbon atoms in the segment.

The monovalent and/or multivalent segments of the fluorinated organosilane compounds are preferably perfluorinated. Preferably, the monovalent segment of the monopodal compounds comprises perfluoroalkyl, perfluoroether, perfluoropolyether, or a combination thereof (more preferably, perfluoroalkyl, perfluoropolyether, or a combination thereof; most preferably, perfluoropolyether), and/or the multivalent segment of the multipodal compounds comprises perfluoroalkane, perfluoroether, perfluoropolyether, or a combination thereof (more preferably, perfluoroalkane, perfluoropolyether, or a combination thereof, most preferably, perfluoropolyether).

In some embodiments, a perfluoroalkyl silane can be utilized which has the formula R′f[Q-(C(R)₂—Si(Y)₃₋ₓ(R^{1a})ₓ]_{y}]_{z}, wherein R′f is perfluoroalkyl, Q=CH₂, R=H, Y=N(CH₃)₂, R^{1a}=Methyl, x=2, y=1, and z=1.

In the most preferred embodiments, a silane can be utilized which has the formula R′f[Q-(C(R)₂—Si(Y)₃₋ₓ(R^{1a})ₓ]_{y}]_{z}, wherein R′f is perfluoroether with the formula F(CF(CF₃)CF₂O)ₐCF(CF₃)—, where a averages 4-120, Q=CONHCH₂CH₂, R=H, Y=OCH₃, R^{1a}=Methyl, x=0, y=1, and z=1.

In the some embodiments, a silane can be utilized which has the formula R′f[Q-(C(R)₂—Si(Y)₃₋ₓ(R^{1a})ₓ]_{y}]_{z}, wherein R′f is perfluoroether with the formula —(CF(CF₃)CF₂O)ₐCF(CF₃)— where a averages 4-120, Q=CH₂OCH₂CH₂, R=H, Y=OCH₃, R^{1a}=Methyl, x=0, y=1, z=1.

### Advancing Water Contact Angle

The advancing water contact angle is measured by using a Rame-Hart goniometer (Rame-Hart Instrument Co., Succasunna, N.J.). Advancing (θ_{adv}) and receding (θ_{rec}) angles were measured as fluid was supplied via a syringe into or out of sessile droplets (drop volume about 5 μL). Measurements were taken at three different spots on each film sample surface, and the reported measurements are the averages of the six values for each sample (a left-side and right-side measurement for each drop). The probe fluid used in this test was deionized water. Contact Angle hysteresis (θ_{hys}) was determined using the following equation: θ_{hys}=θ_{adv}−θ_{rec}.

### Haze

In some embodiments, the polymeric films of the present disclosure may have high transmittance and low haze with respect to one or more specific wavelengths of electromagnetic radiation, e.g. visible radiation (visible light), infrared radiation, ultraviolet radiation, sound and radio waves. In some embodiments, the transmittance of the polymer film to one or more radiation wavelengths may be greater than 80%, greater than 85%, greater than 90 percent, greater than 95% or even greater than 97%. In some embodiments, the transmittance of the polymer film with respect to visible light may be greater than 80%, greater than 85%, greater than 90 percent, greater than 95% or even greater than 97%. In some embodiments, it is a benefit to have the polymeric film maintain a haze measurement of less than 10%, less than 7%, less than 5% or even less than 3% with respect to one or more specific wavelengths of electromagnetic radiation. In some embodiment, the haze of the polymer film with respect to visible light may be less than 10%, less than 7%, less than 5%, percent or even less than 3%. This is specifically useful in embodiments where the polymeric film has a surface that is either hydrophobic or hydrophilic, as defined herein.

Measurements can be determined by using a BYK Haze-Gard Plus (BYK Gardner USA, Columbia, Md.). Measurements should be taken at three different spots on each film sample and averaged.

### Multilayer Films

The polymeric film may be incorporated into a multilayer film, according to the present invention. In one embodiment, the multilayer film comprises a polymeric film and an adhesive layer. The adhesive layer may be a pressure sensitive adhesive or a hot melt adhesive. In such an embodiment, the adhesive layer may bond the polymeric film to the exterior surface, as described herein. In some embodiments, the adhesive layer of the present disclosure may have high transmittance and low haze with respect to one or more specific wavelengths of electromagnetic radiation, e.g. visible radiation (visible light), infrared radiation, ultraviolet radiation, sound and radio waves. In some embodiments, the transmittance of the adhesive layer to one or more radiation wavelengths may be greater than 80%, greater than 85%, greater than 90 percent, greater than 95% or even greater than 97%. In some embodiments, the transmittance of the adhesive layer with respect to visible light may be greater than 80%, greater than 85%, greater than 90 percent, greater than 95% or even greater than 97%. In some embodiments, it is a benefit to have the adhesive layer maintain a haze measurement of less than 10%, less than 7%, less than 5% or even less than 3% with respect to one or more specific wavelengths of electromagnetic radiation. In some embodiment, the haze of the adhesive layer with respect to visible light may be less than 10%, less than 7%, less than 5%, percent or even less than 3%. The polymeric film may be in a multilayer structure with additional polymer layers between the polymeric film and the adhesive layer. Such structures are found, for example, in U.S. Publication No. 2017/0107398A1 incorporated herein by reference in its entirety.

### Methods of Making the Polymeric Film

The polymeric films of the present application can be made using known techniques. Examples of making a polymeric film include, for example, melt extrusion, melt blowing, or reacting/crosslinking monomeric species. Film manufacturing methods are well disclosed in, e.g. U.S. Pat. No. 8,765,263 and U.S. Publication No. 2017/0107398, incorporated by reference in their entirety.

### Methods of Depositing the Fluorochemical

The fluorinated organosilanes can be deposited using known coating methods such as dip coating. In some embodiments, the fluorinated composition is vapor deposited.

If using vapor deposition, the conditions under which the fluorinated composition can be vaporized during chemical vapor deposition can vary according to the structures and molecular weights of the fluorinated organosilanes. For certain embodiments, the vaporizing can take place at pressures less than about 1.3 Pa (about 0.01 torr), at pressures less than about 0.013 Pa (about 10-4 torr), or even at about 0.0013 Pa to about 0.00013 Pa (about 10-s torr to about 10-6 torr). For certain of these embodiments, the vaporizing can take place at temperatures of at least about 80° C., at least about 100° C., at least about 200° C., or at least about 300° C. Vaporizing can include imparting energy by, for example, conductive heating, convective heating, and/or microwave radiation heating.

### Polymeric Protective Films and Methods of Using

The polymeric films described herein can be added to the surface to be protected, for example the exterior surface of a vehicle sensor system. Polymeric films having a hydrophobic surface are useful as protective films for vehicle sensors, for example, because rain and saltwater are dewetted from the surface. In some embodiments, hydrophobic protective films comprise a hardcoat layer for durability. For example, in some embodiments, hydrophobic protective films comprise a polymeric substrate, an optional nanostructure, a hardcoat layer, and a nanostructured hydrophobic surface (e.g., plasma-treated or HFPO).

In some embodiments, the polymeric film is coated with a hydrophobically-modified silica-containing layer. Examples of hydrophobically-modified silica-containing layers include Armor All Wheel Protectant, part number 78482, available from The Armor All/STP Products Company, Oakland, Calif., and a solution of AEROSIL® R 812(s) available from Evonik (e.g., 0.5% solution in alcohol or silica-based solvents). In some embodiments, the polymeric film is a polyurethane. In some embodiments, the polymeric film is a multilayer film, more particularly a multilayer film comprising an adhesive on the side of the polymeric film opposite the side containing the coating.

Polymeric films having a hydrophilic surface are also useful as protective films for vehicle sensors, for example, because they resist fog. In some embodiments, hydrophilic protective films comprise a hardcoat layer for durability. In some embodiments, hydrophilic protective films are coated with a DLG and a hydrophilic coating to provide washability as well as fog resistance. For example, in some embodiments, hydrophilic protective films comprise a polymeric substrate, an optional nanostructure, a hardcoat layer, a DLG layer and a hydrophilic coating (e.g., a zwitterionic silane).

The polymeric films described herein can be added to the surface to be protected using methods known in the art. For example, a premask may be used to assist in the application process. Specifically, applying the polymeric films to a substrate (e.g. an exterior surface of a vehicle sensor system) using a layer of pre-mask material comprising a polymeric cover sheet or layer and a layer of removable pressure-sensitive adhesive firmly adhered to one surface of the cover sheet with the layer of pre-mask material, wherein the premask is removed after placement. Additionally, the film may be die-cut to match a desired surface to be protected.

### EXAMPLES

### Test Methods

### Fluid Contact Angle Test Method.

Fluid contact angles of a film sample were measured using a Rame-Hart goniometer (Rame-Hart Instrument Co., Succasunna, N.J.). Advancing (θ_{adv}) and receding (θ_{rec}) angles were measured as fluid was supplied via a syringe into or out of sessile droplets (beginning drop volume about 5 μL) following the method described in Korhonen et. al (Langmuir, 2013, 29, 3858-3863). Measurements were taken at three different spots on each film sample surface, and the reported measurements are the averages of the six values for each sample (a left-side and right-side measurement for each drop). The probe fluid used in this test was deionized water unless otherwise specified. Contact Angle hysteresis (θ_{hys}) was determined using the following equation: ∂_{hys}=θ_{adv}−θ_{rec}.

### Transmittance and Haze Measurement Test Method.

Transmittance and haze measurements of a film sample were made using a BYK Haze-Gard Plus (BYK Gardner USA, Columbia, Md.). Measurements were taken at three different spots on each film sample and the reported values are the averages of the three measurements.

Preparation of samples for the Transmittance and Haze Measurement Test Method was as follows. A 1 inch (2.5 cm)×2 inch (5.1 cm) film sample was cut. The PET liner was removed from the sample and the adhesive side of the film was placed on a pre-wetted (distilled water) Swiss glass slide, available from Fischer Scientific, Hampton, N.H. The PET liner was then placed on top of the exposed surface to protect the surface of the sample. Excess water from underneath the adhesive was squeegeed out by gently pressing on top of the PET liner covered sample. The PET liner was then removed from the surface of the film sample. The laminated sample on the glass slide was allowed to dry at room temperature overnight before transmittance and haze measurements were taken. This drying step ensured that residual water remaining under the film after the squeegeeing process would evaporate and not influence the transmittance and haze measurements.

### Aerosol Salt Water Spray Resistance Test Method

A PREVAL Spray Unit Model #267 (available from Precision Valve Corporation, Rye Brook, N.Y.) was charged with a salt solution. The salt solution consisted of 10 grams of MORTON FAST ACTION ICE MELT salt, which is a blend of calcium chloride and sodium chloride, (available from Morton Salt, Inc. Chicago, Ill.), 0.2 grams of McCormick red food coloring (available from McCormick & Company, Baltimore, Md.), and 100 grams of distilled water. The components were mixed for about 3 minutes until the salt completely dissolved. The spray unit was held about 9 inches (23 cm) away from the surface of a sample. The sample was then sprayed with the salt solution for 10 seconds which resulted in about 7.5 g of salt solution dispensed onto the sample. After spraying, a sample was rated based on the amount of liquid that remained on the sample using the following criteria:

0=No salt solution remaining on the sample.
1=A few, small droplets of salt solution remained on the film sample or the salt solution completely wetted the film sample (thin layer).
2=Some small droplets of salt solution remained on the film sample.
3=Some large droplets of salt solution remained on the film sample.
4=A large number of droplets of salt solution (large or small) remained on the film sample.
5=The entire film surface covered by the salt solution.
A lower rating indicated improved performance.
Preparation of samples for the Aerosol Salt Water Spray Resistance Test Method was as follows. Film samples were prepared by taking a small piece of the film sample containing the liner and adhering the film to a 2 inch (5.1 cm)×3 inch (7.6 cm) Swiss glass slide, available from Fischer Scientific, Hampton, N.H., using removable double-sided tape (3M ID Number 34-8518-3091-8), available from 3M Company, St. Paul, Minn. The liquid sample, Armor All Wheel Protectant, part number 78482, available from The Armor All/STP Products Company, Oakland, Calif., was sprayed onto a Swiss glass slide and allowed to dry overnight. Prior to evaluating this Armor All Wheel Protectant coating, a small piece of PPF film containing the liner was adhered to the back of the uncoated side of the coated glass slide using the removable double-sided tape. For a Swiss glass slide (Comparative Example 1), prior to testing, a small piece of PPF film containing the liner was adhered to the back of the glass panel using the removable double-sided tape. PPF film was attached to the uncoated back of (i) the Armor All Wheel Protectant coated glass slide and (ii) the bare glass slide (Comparative Example 1) to ensure consistent visualization of each sample. In other words, PPF film and a glass slide were common elements in all test samples.

### Dry Dirt Pickup Test Method:

20 grams of dry dirt, 3M Standard Carpet Dry Soil SPS-2001, available from the 3M Company, St. Paul, Minn., was added to a pint paint can with a lid. A film sample was placed into the paint can and the lid was secured. Once closed, the can containing the sample was inverted 20 times. The lid was then removed and the film sample removed from the can. The back side of the film sample was gently tapped 3 times, to remove loose dirt. The film samples were then rated according to the following criteria:

0=No dirt on the sample.
1=Very light dirt coverage on the sample.
2=Light dirt coverage on the sample.
3=Moderate dirt coverage on the sample.
4=Significant dirt coverage on the sample.
5=Complete dirt coverage of the sample.

Preparation of samples for the Dirt Pickup Test Method was identical to that as described for the sample preparation for the Aerosol Salt Water Spray Resistance Test Method.

### Oil Cleaning Test Method

About 0.5 grams of used motor oil (Valvoline Synthetic Motor Oil 10W-30) was placed on a sample in a straight line. A polyethylene squirt bottle containing distilled water was then used to apply distilled water onto the samples. The bottle was held about 4 inches (10.2 cm) from the sample and water was sprayed onto the oil for 10 seconds. The amount of water squirted onto a sample was about 4 grams. The samples were then rated based on the amount of motor oil remaining on the samples using the following criteria.

0=No oil on the sample.
1=Very little oil on the sample.
2=Small amount of oil on the sample.
3=Moderate amount of oil on the sample.
4=Significant amount of oil on the sample.
5=No oil removed from the sample.
Preparation of samples for the Oil Cleaning Test Method was identical to that as described for the sample preparation for the Aerosol Salt Water Spray Resistance Test Method.

### Static Contact Angle Test

Measurements were made using as-received, reagent-grade hexadecane and filtered deionized water on a Kruss video contact angle analyzer available as product number DSA 100S from Kruss GmbH (Hamburg, Germany). Static contact angle (θ_{static}) was measured as fluid was supplied via a syringe to the substrate with drop volumes of about 4-5 microliters for static water contact angle measurements and 2-3 microliters for static hexadecane contact angle measurements. The film sample was brought into contact with the bottom of the drop of water or hexadecane; then, the syringe and film sample were separated causing the drop to be only in contact with the film sample. Once the drop was on the substrate, the contact angle was measured. Measurements were taken at two to three different spots on each film sample surface, and the reported measurements are the averages of the values for each sample.

Table of Materials

| Material | Description | Source |
|---|---|---|
| C4DMA | Nonafluorohexyldimethyl(dimethylamino)silane | Gelest (Morrisville, |
| | | PA) |
| HFPO/Si | A hexafluoropropyleneoxide | |
| | (HFPO) amide silane synthesized as described | |
| | above. | |
| N1720 | 3M Novec 1720 Electronic Grade Coating | 3M Company (St. |
| | Fluid. Contains the perfluoropolyether (PFPE) | Paul, MN) |
| | amido silane active compound, this chemistry | |
| | was disclosed in prior issued U.S. Pat. No. | |
| | 8,158,264, which is incorporated herein by | |
| | reference in its entirety. The fluoropolymer is | |
| | supplied as a 0.1 wt % solution in 3M Novec | |
| | 7100 Engineered Fluid. | |
| HD | n-Hexadecane | Alfa Aesar, |
| | | (Tweksbury, MA) |
| HFE-7200 | 3M ™ Novec ™ 7200 Engineered Fluid, ethoxy- | 3M Company (St. |
| | nonafluorobutane (C₄F₉OC₂H₅). | Paul, MN) |
| K-Kat 670 | K-Kat 670 Non-tin catalyst for silane terminated | King Industries |
| | polymers | (Norwalk, CT) |
| N2202 | 3M Novec 2202, hexafluoropropyleneoxide | 3M Company (St. |
| | (HFPO) ether silane having a molecular weight | Paul, MN) |
| | of 8 KDa, this new chemistry was disclosed as | |
| | nominally in example Cl in published patent | |
| | application WO 2013126208A which is | |
| | incorporated herein by reference in its entirety. | |
| | The fluoropolymer is supplied as a 0.2 wt % | |
| | solution in 3M Novec 7200 Engineered Fluid. | |
| HFPO/Si-B | (HFPO) ether silane having a molecular weight | |
| | of 6 KDa, was disclosed as nominally in | |
| | example Bl in published patent application WO | |
| | 2013126208A. The material was supplied as a | |
| | 24.36 wt % solution in HFE-7200. | |

### Preparation of Zwitterionic Silane Solution

3-(N,N-dimethylaminopropyl)trimethoxysilane (49.7 g, 239 mmol) was added to a screw-top jar followed by deionized (DI) water (82.2 g) and 1,4-butane sultone (32.6 g, 239 mmol). The reaction mixture was heated to 75° C. and mixed for 14 hours. This 50 wt % zwitterionic silane solution was used in the preparation of Zwit1 described below.

### Preparation of Zwitterionic Silane/Lithium Silicate Coating Solution (Zwit1)

Zwit1 was prepared as follows: Distilled water (41.8 g) was added to a vial containing a magnetic stir bar. The vial was placed on top of a magnetic stir plate and the following were added dropwise to the vial while stirring: isopropyl alcohol (5.0 g, 99% purity, obtained from Sigma Aldrich, St. Louis Mo.), Zwitterionic Silane Solution (1.33 g, 50 wt % in deionized water), lithium silicate solution (1.52 g, 22% solids LSS-75 from Nissan Chemicals, Houston Tex., in deionized water;), and surfactant (0.25 g, 39% solids Polystep B430S, Stepan Company, Northfield, Ill., in deionized water). After all of the raw materials were added for the Zwit1 solution, the Zwit1 solution was stirred for 1 hour prior to use.

### Preparation of Surface Modified 190 nm Silica Particles (SMNP190 Dispersion)

Prior to surface modification, the nanoparticle underwent two ion exchange processes. Supelco Dowex Monosphere 550A ion exchange resin (94 grams, available from Sigma-Aldrich, St. Louis, Mo.) was mixed with non-functionalized nanoparticles (1883.5 grams, 39.02% solids, pH=9.34, available under the trade designation “MP2040” available from Nissan Chemical, Houston, Tex.) and allowed to stir for approximately 10 minutes until the mixture reached a pH=11.15. The ion exchange resin was separated from the treated nanoparticles sol to prepare for the second ion exchange step. Amberlite IR120(H) ion exchange resin (94 grams, Sigma-Aldrich, St. Louis, Mo.) was mixed into the anion exchanged nanoparticle sol, allowed to stir for approximately 30 minutes until the mixture reached a pH=2.16. The ion exchange resin was separated from the treated nanoparticle sol for addition of base for stabilization. The double ion exchanged nanoparticles sol was mixed with ammonium hydroxide (2.77 grams) to obtain a final mixture with a pH=9.30. The resulting solids content of the double ion exchanged sol was determined to be 37.30% and the mixture was transferred to a plastic bottle.

The double ion exchanged nanoparticles were surface modified as follows. 1-methoxy-2-propanol (899.90 grams, Alfa Aesar, Ward Hill, Mass.), 3-methacryloyloxypropyltrimethoxysilane (5.43 grams, Alfa Aesar, Ward Hill, Mass.) and radical inhibitor solution (0.42 gram of a 5 wt % solution of 4-Hydroxy-TEMPO, available form Alfa Aesar, in deionized water) were mixed with the double ion-exchanged MP2040 nanoparticles (800.00 grams, 37.30% solids) while stirring. The solution was sealed and heated to 85° C. and held at temperature for 16 hours in a 2000 mL round bottom flask fitted with a reflux condenser and mechanical stirrer. The surface modified colloidal dispersion was further processed to remove water and increase the silica concentration, yielding SMNP190. The resulting modified silica content solids after the solvent exchange was 47.16 wt %.

### Preparation of Surface Modified 440 nm Silica Particles (SMNP440 Dispersion)

Prior to surface modification, the nanoparticle underwent two ion exchange processes. Dowex Monosphere 550A ion exchange resin (105.5 grams, Sigma-Aldrich) was mixed with non-functionalized nanoparticles (2109.1 grams, 40.47% solids, pH=8.15, available under the trade designation “MP4540” from Nissan Chemical) and allowed to stir for approximately 10 minutes until the mixture reached a pH=9.89. The ion exchange resin was separated from the treated nanoparticles sol to prepare for the second ion exchange step. Amberlite IR120(H) ion exchange resin (105.5 grams, Sigma-Aldrich) was mixed into the anion exchanged nanoparticle sol, allowed to stir for approximately 20 minutes until the mixture reached a pH=3.70. The ion exchange resin was separated from the treated nanoparticle sol for addition of base for stabilization. The double ion exchanged nanoparticles sol was mixed with ammonium hydroxide (15 drops) to obtain a final pH=9.26. The resulting solids content of the double ion exchanged sol was determined to be 40.41% and the mixture was transferred to a plastic bottle.

The double ion exchanged nanoparticles were surface modified as follows. 1-methoxy-2-propanol (810.2 grams, Alfa Aesar), 3-methacryloyloxypropyltrimethoxysilane (2.02 grams, Alfa Aesar) and radical inhibitor solution (0.31 gram of a 5 wt % solution of 4-Hydroxy-TEMPO, available form Alfa Aesar, in deionized water) were mixed with the double ion-exchanged MP4540 nanoparticles (719.83 grams, 40.41% solids) while stirring. The solution was sealed and heated to 85° C. and held at temperature for 16 hours in a 2000 mL round bottom flask fitted with a reflux condenser and mechanical stirrer. The surface modified colloidal dispersion was further processed to remove water and increase the silica concentration. The resulting modified silica content solids after the solvent exchange was 48.55 wt %.

### HFPO Silane Synthesis

The HFPO silane was prepared according to the procedure described in US Patent application U.S. Publication No. 2013/0229378 A1 (in paragraphs 0120 and 0121, description clipped and pasted below).

“HFPO” refers to the end group F(CF(CF₃) CF₂O), CF(CF₃) of the methyl ester F(CF(CF₃)CF₂O)ₐCF(CF₃)C(O)OCH₃, wherein a averages from 4-20, which can be prepared according to the method described in U.S. Pat. No. 3,250,808 (Moore et al.), the description of which is incorporated herein by reference, with purification by fractional distillation. “HFPO—Si” (HFPO—CONHCH₂CH₂CH₂Si(OCH₃)₃) was prepared as follows: A 100 mL 3-necked, round bottom flask equipped with a magnetic stir bar, nitrogen (N₂) inlet, and reflux condenser was charged with HFPO—COOCH₃ (20 g, 0.01579 mole) and NH₂CH₂CH₂CH₂ Si(OCH₃)₃ (2.82 g, 0.01579 mole) under a N₂ atmosphere. The resulting reaction mixture was heated at 75° C. for 12 hours. The reaction was monitored by infrared (IR) spectroscopy, and, after the disappearance of the ester peak, the resulting clear, viscous oil was kept under vacuum for another 8 hours and used as such.

### Plasma Treatment Process

General plasma processing techniques can be found in U.S. Pat. No. 5,888,594 and U.S. Publication No. 2017/0067150, both of which are incorporated by reference in their entirety, herein. Plasma treatment was carried out by using a homebuilt plasma treatment system described in detail in U.S. Pat. No. 5,888,594 (David et al.) with some modifications. The width of the drum electrode was increased to 42.5 inches (108 cm) and the separation between the two compartments within the plasma system was removed so that all the pumping was carried out by means of the turbo-molecular pump and thus operating at a process pressure of around 10-50 mTorr.

A roll of polymeric film, either primed PET or PPF (SCOTCHGARD PAINT PROTECTION FILM PRO SERIES film, product identification number: 75-3472-6043-4, available from 3M Company, St. Paul, Minn.) was mounted within the chamber. The film was wrapped around the drum electrode and was secured to the take up roll on the opposite side of the drum. The unwind and take-up tensions are shown in Table 1. The chamber door was closed and the chamber pumped down to a base pressure of 5×10⁻⁴ torr. For each of the examples, multiple passes through the chamber were carried out by moving the substrates back and forth, enabling multiple treatments on the same samples. Specific plasma processing conditions are shown in Table 1.

TABLE 1
Plasma Treatment Conditions

| | | | | Gas 1 | Gas 2 | | | | Tension |
|---|---|---|---|---|---|---|---|---|---|
| | Plasma | | | Flow | Flow | Rf | Line | | (Left/ |
| | Pass | | | Rate | Rate | Power | Speed | Pressure | Right) |
| Sample | Number | Gas 1 | Gas 2 | (sccm) | (sccm) | (watts) | (ft/min) | (mTorr) | (lbs) |
| 3 | 1 | HMDSO | O₂ | 12 | 750 | 7500 | 2.5 | 16.0 | 4/10 |
| | 2 | HMDSO | — | Open | — | 2000 | 30 | 38.0 | 6/12 |
| 4 | 1 | HMDSO | O₂ | 12 | 750 | 7500 | 10 | 16.0 | 4/10 |
| | 2 | C₆F₁₂O | O₂ | 20 | 80 | 7500 | 7.5 | 3.6 | 6/12 |
| | 3 | HMDSO | — | 1600 | — | 2000 | 30 | 9.8 | 6/12 |
| 5 | 1 | HMDSO | O₂ | 12 | 750 | 7500 | 10 | 16.0 | 4/10 |
| | 2 | HMDSO | O₂ | 12 | 750 | 7500 | 2.5 | 16.0 | 4/10 |
| | 3 | HMDSO | — | Open | — | 2000 | 30 | 38.0 | 6/12 |
| 6 | 1 | HMDSO | O₂ | 12 | 750 | 7500 | 10 | 16.0 | 4/10 |
| | 2 | HMDSO | O₂ | 12 | 750 | 7500 | 2.5 | 16.0 | 4/10 |
| | 3 | HMDSO | — | Open | — | 2000 | 30 | 38.0 | 6/12 |
| 7 | 1 | HMDSO | O₂ | 12 | 750 | 7500 | 10 | 16.0 | 4/10 |
| | 2 | C₆F₁₂O | O₂ | 20 | 80 | 7500 | 7.5 | 3.6 | 6/12 |
| | 3 | HMDSO | — | 1600 | — | 2000 | 30 | 9.8 | 6/12 |
| | 4 | HMDSO | O₂ | 100 | 1000 | 9500 | 10 | 28.0 | 20 |
| | 5 | — | O₂ | — | 1000 | 5000 | 10 | 7.1 | 10 |
| 8 | 1 | HMDSO | O₂ | 100 | 1000 | 9500 | 10 | 28.0 | 20 |
| | 2 | — | O₂ | — | 1000 | 5000 | 10 | 7.1 | 10 |

After the samples were treated in the above manner, the rf power was disabled, oxygen flow stopped, chamber vented to the atmosphere, and the samples taken out of the plasma system for further processing.

### Comparative Example 1

A 2 inch (5.1 cm)×3 inch (7.6) Swiss glass slide, obtained from Fischer Scientific, Hampton, N.H.

### Comparative Example 2

Refers to the front facing transparent substrate on an optical vehicle sensor part number EL3T, available from Ford Motor Company, Dearborn, Mich.

### Comparative Example 3

A vertically oriented Swiss glass slide was sprayed with Armor All Wheel Protectant, part number 78482. The slide was initially dried for about 1 hour and remained vertical during this time to ensure a uniform coating. The coated slide was dried overnight prior to testing.

### Comparative Example 4

0.5 g of the Zwit1 solution was added via pipette to the surface of a glass slide. Zwit1 solution was then spread out evenly onto the slide using a KimWipe (EX-L, available from Kimberly-Clark, Irving, Tex.) and allowed to dry at room temperature overnight prior to measurements being taken.

### Example 1

SCOTCHGARD PAINT PROTECTION FILM PRO SERIES film (product identification number: 75-3472-6043-4) available from 3M Company, St. Paul, Minn., referred herein as PPF.

### Example 2

A 1 inch (2.5 cm) circular die-cut of PPF was applied to a Swiss glass slide, via the adhesive of the PPF. The PPF surface was then sprayed with Armor All Wheel Protectant, part number 78482, available from The Armor All/STP Products Company, Oakland, Calif. The slide was initially dried for about 1 hour and remained vertical during this time to ensure a uniform coating. The coated slide was dried overnight prior to testing.

### Example 3

The top surface of PPF was plasma treated, according to the conditions described in Table 1, to form nano size features on the surface. Following etching, organosilicone groups were reacted onto the surface from a hexamethyldisiloxane plasma treatment, as described in Table 1, Plasma Pass2.

### Example 4

PPF was plasma treated according to the conditions described in Table 1, Plasma Pass 1. SilFORT* UVHC3000, a hardcoat available from Momentive Performance Materials, Inc., Columbus, Ohio, was Mayer rod coated via a #6 wire wound rod onto the plasma treated PPF surface. The solvent was flashed off over 15 minutes in an exhaust oven set to 170° F. Once the solvent was removed, the coated PPF was cured using a 300 watt fusion H-bulb at a line speed of 10 ft/min (3.0 m/min). The cured UVHC3000 hardcoat thickness was about 3 microns. Following curing, the coated PPF film was reactive ion etched as described in Table 1, Plasma Pass 2, forming nano-size features on the surface. Following etching, organosilicone groups were reacted onto the surface from a hexamethyldisiloxane plasma treatment, as described in Table 1, Plasma Pass 3.

### Example 5

PPF was plasma treated according to the conditions described in Table 1, Plasma Pass 1. A hardcoat composition containing 57.3% HFPO-UA (30 wt. % solids soln.), 17.0 wt % CN9010 (100% solids, available from Sartomer Americas, Exton, Pa.), 0.3 wt % Esacure One (available from IGM Resins USA, Inc., Charlotte, N.C.); and 25.4 wt % methyl ethyl ketone was coated onto the plasma treated PPF surface, using a die coater to give a 5 micron thick dry coating and a line speed of 10 ft/min (3.0 m/min). The preparation of the HFPO-UA, 30% solids solution, can be found in U.S. Pat. No. 8,728,623, column 15, the section titled “Preparation of DES N100/0.95 PET3A/0.10 HFPO—C(O)NHCH₂CH₂OH (HFPO Urethane 1)”. Once coated, the solvent of the hard coat composition was flashed off in a 170° F. oven and the composition was cured using a 300 watt fusion H-bulb at a line speed of 10 ft/min (3.0 m/min). Following curing, the coated PPF film was reactive ion etched as described in Table 1, Plasma Pass 2, forming nano-size features on the surface. Following etching, organosilicon groups were reacted onto the surface from a hexamethyldisiloxane plasma treatment, as described in Table 1, Plasma Pass 3.

### Example 6

PPF was plasma treated according to the conditions described in Table 1, Plasma Pass 1. A hardcoat composition containing: 42.2 wt % HFPO-UA (30 wt. % solids soln.), 12.5 wt % CN9010 (100% solids), 19.5 wt % SMNP440 Dispersion (48.55 wt % solids), 0.3 wt % Esacure One; and 25.4 wt % methyl ethyl ketone was coated onto the plasma treated PPF surface, using a die coater to give a 5 micron thick dry coating and a line speed of 10 ft/min (3.0 m/min). Once coated the solvent was flashed off in a 170° F. oven and cured using a 300 watt fusion H-bulb at a line speed of 10 ft/min. Following curing, the coated PPF film was reactive ion etched as described in Table 1, Plasma Pass 2, forming nano-size features on the surface. Following etching, organosilicon groups were reacted onto the surface from a hexamethyldisiloxane plasma treatment, as described in Table 1, Plasma Pass 3.

### Example 7

PPF was plasma treated according to the conditions described in Table 1, Plasma Pass 1. A hardcoat composition containing 71 wt % Momentive UVHC 3000 (45% solids) and 29 wt % SMNP190 Dispersion (47.16 wt % solids) was Mayer rod coated onto the surface of a primed PET film using a #6 wire wound rod. Once coated, the solvent was flashed off in a 170° F. oven and cured using a 300 watt fusion H-bulb at a line speed of 18 ft/min (5.5 m/min). Following curing, the coated PPF film was reactive ion etched as described in Table 1, Plasma Pass 2, to etch the surface. Following etching, a layer of diamond like glass (DLG) was deposited onto the plasma treated surface as described in Table 1, Plasma Pass 3, 4 and 5. The DLG coated film was then dip coated using NOVEC 2202, available from 3M Company, St. Paul, Minn. After dip coating, the sample was baked in an oven at 105° C. for 1 hour.

### Example 8

DLG (diamond like glass) was deposited onto the top surface of an 8 inch (20.3 cm)×12 inch (30.5 cm) piece of PPF, as described in Table 1, Plasma Pass 1 and 2. Following DLG deposition, 1.0 grams of Zwit1 solution was applied to the DLG coated surface. Zwit1 solution was then spread out evenly onto the surface using a KimWipe (EX-L) and allowed to dry at room temperature overnight prior to measurements being taken.

### Examples 9-13

PPF was plasma treated according to the conditions described in Table 1, Plasma Pass 1. A hardcoat composition containing: 42.2 wt % HFPO-urethane acrylate (30 wt % % solids soln.), 12.5 wt % CN9010 (100% solids), 19.5 wt % SMNP440 Dispersion (48.55 wt % solids), 0.3 wt % Esacure One; and 25.4 wt % methyl ethyl ketone was coated onto the plasma treated PPF surface, using a die coater to give a 5 micron thick dry coating and a line speed of 10 ft/min (3.0 m/min). Once coated, the solvent was flashed off in a 77 C oven and cured using a 300 watt fusion H bulb at a line speed of 10 ft/min. Following curing, the coated PPF film was reactive ion etched as described in Table 1, Plasma Pass 2, to etch the surface.

In some examples, following etching, a layer of diamond like glass (DLG) was deposited onto the plasma treated surface as described in Table 1, Plasma Pass 3, 4 and 5.

The film was then vapor coated with a silane compound using the apparatus described in US patent application US 2009/0263668 A1. Approximately 0.5 ml of the silane precursor liquid was dispensed to each of the graphite heating cloths. The base pressure in the chamber was 1 mTorr before the electrical power to the evaporator cloths was turned on to heat the cloth to approximately 220 C. The chamber was isolated from the vacuum pump, and the evaporated precursor was equilibrated within the chamber for 3 minutes, after which the electrical power to the heating cloth was disabled, and the chamber vented to atmosphere.

Optionally, after vapor coating, the sample was baked in an oven at 90° C. for at least 15 minutes.

### Examples 14-21

Example coating solutions 14-21 were then prepared using the amounts in Table 8. The solutions were mixed in 40 mL glass vials by adding fluoropolymer solution of the indicated concentration, then HFE-7200, then the above K-Kat 670 solution to the vials followed by mixing using a vortex mixer ((VWR, Radnor, Pa.).

### Examples 22-33

PPF was plasma treated according to the conditions described in Table 1, Plasma Pass 1. A hardcoat composition containing: 42.2 wt % HFPO-urethan acrylate (30 wt % % solids soln.), 12.5 wt % CN9010 (100% solids), 19.5 wt % SMNP440 Dispersion (48.55 wt % solids), 0.3 wt % Esacure One; and 25.4 wt % methyl ethyl ketone was coated onto the plasma treated PPF surface, using a die coater to give a 5 micron thick dry coating and a line speed of 10 ft/min (3.0 m/min). Once coated, the solvent was flashed off in a 77° C. oven and cured using a 300 watt fusion H bulb at a line speed of 10 ft/min. Following curing, the coated PPF film was reactive ion etched as described in Table 1, Plasma Pass 2, to etch the surface. A layer of diamond like glass (DLG) was deposited onto the plasma treated surface as described in Table 1, Plasma Pass 3, 4 and 5.

The film was then coated with the silane solutions described in samples 14-21 compound using a 2″ square frame film applicator (BYK-Garnder, Geretsried, Germany). These samples were baked in an oven at 85° C. for 15-20 minutes. Contact angle testing was done 1-2 weeks after curing.

Testing Results for various Examples and Comparative Examples are shown in Tables 2-7 below.

TABLE 2
Results of the Fluid Contact Angle Test

Water Contact Angle (degrees)

| Sample | Advancing | Receding | Hysteresis |
|---|---|---|---|
| Comparative Example 1 | <5 | <5 | <1 |
| Comparative Example 2 | — | — | — |
| Comparative Example 3 | 83 | 50 | 33 |
| Comparative Example 4 | <5 | <5 | <1 |
| Example 1 | 90 | 67 | 23 |
| Example 2 | 167 | 157 | 10 |
| Example 3 | 164 | 136 | 28 |
| Example 4 | 156 | 135 | 21 |
| Example 5 | 165 | 162 | 3 |
| Example 6 | 166 | 165.5 | 0.5 |
| Example 7 | 155 | 123.5 | 31.5 |
| Example 8 | <5 | <5 | <1 |

TABLE 3
Results of the Transmittance and Haze Measurement Test

| Sample | Transmittance (%) | Haze (%) |
|---|---|---|
| Comparative Example 1 | 93.1 | 0.26 |
| Comparative Example 2 | — | — |
| Comparative Example 3 | 94.6 | 0.7 |
| Comparative Example 4 | 93.2 | 0.27 |
| Example 1 | 93.1 | 0.67 |
| Example 2 | 94.5 | 0.59 |
| Example 3 | 93.4 | 1.21 |
| Example 4 | 93.8 | 1.10 |
| Example 5 | 95.9 | 0.5 |
| Example 6 | 88.1 | 83.1 |
| Example 7 | 97.7 | 2.71 |
| Example 8 | 92.7 | 3.51 |

TABLE 4
Results of the Aerosol Salt Water Spray Resistance Test

| Sample | Rating |
|---|---|
| Comparative Example 1 | 1 |
| Comparative Example 3 | 3 |
| Example 1 | 3 |
| Example 2 | 1 |
| Example 3 | 4 |
| Example 5 | 0 |
| Example 8 | 1 |

TABLE 5
Results of the Dry Dirt Pickup Test

| Sample | Rating |
|---|---|
| Comparative Example 1 | 2 |
| Comparative Example 3 | 4 |
| Example 1 | 2 |
| Example 2 | 3 |
| Example 3 | 0 |
| Example 5 | 0 |
| Example 8 | 3 |

TABLE 6
Results of the Oil Cleaning Test

| Sample | Rating |
|---|---|
| Comparative Example 1 | 1 |
| Comparative Example 3 | 3 |
| Example 1 | 2 |
| Example 2 | 4 |
| Example 3 | 3 |
| Example 5 | 3 |
| Example 8 | 0 |

TABLE 7
Contact Angle Results on Treated Films

| Sample | DLG | Silane | Bake | θₛₜₐ H₂O | θ_{adv} H₂O | θ_{rec} H₂O | θₛₜₐ HD | θ_{adv} HD | θ_{rec} HD |
|---|---|---|---|---|---|---|---|---|---|
| 9 | No | N1720 | Yes | 148° | | | 0° | | |
| 10 | No | C4DMA | Yes | 136° | | | 0° | | |
| 11 | Yes | C4DMA | No | 148° | 149° | 147° | 83° | | |
| 12 | Yes | C4DMA | Yes | NM | | | 68° | | |
| 13 | Yes | HFPO/Si | Yes | NM | 165° | 164° | 118° | 125° | 90° |

DLG = Diamond-like glass coating applied. NM = not measurable because the drop would not transfer from the needle to the substrate. θₛₜₐ H₂O = static water contact angle, θ_{adv} H₂O = advancing water contact angle, θ_{rec} H₂O = receding water contact angle, θₛₜₐ HD = static hexadecane contact angle, θ_{adv} HD = advancing hexadecane contact angle, θ_{rec} HD = receding hexadecane contact angle.

TABLE 8
Formulations for Liquid Fluoropolymer Coatings.

| | | | | | | Final |
|---|---|---|---|---|---|---|
| | | Input | | Amt | Amt. K- | Fluoropolymer |
| | | Fluropolymer | Fluoro- | HFE- | Kat 670 | Solution |
| | Fluoro- | Concentration | polymer | 7200 | Solution³ | Concentration |
| Sample | polymer | (wt %) | Amt. (g) | (g) | (g) | (wt %) |
| 14 | N1720¹ | 0.1% | 39.94 | 0 | 0.38 | 0.1 |
| 15 | N2202² | 0.2% | 20.00 | 19.6 | 0.37 | 0.1 |
| 16 | HFPO/Si | 100% | 0.040 | 39.6 | 0.38 | 0.1 |
| 17 | HFPO/Si-B | 24.36% | 0.164 | 39.5 | 0.37 | 0.1 |
| 18 | N1720¹ | 0.506% | 39.5 | 0 | 1.7 | 0.5 |
| 19 | N2202² | 0.793% | 25.2 | 13.0 | 1.7 | 0.5 |
| 20 | HFPO/Si | 100% | 0.201 | 39.6 | 1.9 | 0.5 |
| 21 | HFPO/Si-B | 24.36% | 0.829 | 37.5 | 1.7 | 0.5 |

¹Novec 1720 (0.1 wt % fluoropolymer) was concentrated to 0.506 wt % by rotary evaporation.
²Novec 2202 (0.2 wt % fluoropolymer) was concentrated to 0.793 wt % by rotary evaporation.
³K-Kat 670 solution was prepared by adding K-Kat 670 (0.0635 g) to a glass vial, followed by 18.182 g HFE-7200. This blend was mixed thoroughly with a vortex mixer (VWR, Radnor, PA).

TABLE 9
Results from Liquid Coatings

| | | | Coater | | | | |
|---|---|---|---|---|---|---|---|
| | | | Gap | | | | |
| | Fluoropolymer | Fluropolymer | Clearance | | | | |
| Example | Solution | Concentration | (mil) | θ_{adv} H₂O | θ_{rec} H₂O | θ_{adv} HD | θ_{rec} HD |
| 22 | 14 | 0.1% | 8 | 165 | 165 | 108 | 63 |
| 23 | 15 | 0.1% | 8 | 164 | 164 | 100 | NM |
| 24 | 16 | 0.1% | 8 | 159 | 158 | 93 | NM |
| 25 | 17 | 0.1% | 8 | 167 | 166 | 116 | NM |
| 26 | 18 | 0.5% | 3 | 169 | 165 | 73 | NM |
| 27 | 19 | 0.5% | 3 | 161 | 161 | 71 | NM |
| 28 | 20 | 0.5% | 3 | 165 | 164 | 85 | NM |
| 29 | 21 | 0.5% | 3 | 165 | 163 | 90 | NM |
| 30 | 18 | 0.5% | 8 | 100 | 61 | 75 | NM |
| 31 | 19 | 0.5% | 8 | 154 | 148 | 87 | NM |
| 32 | 20 | 0.5% | 8 | 149 | 105 | 95 | NM |
| 33 | 21 | 0.5% | 8 | 161 | 159 | 119 | NM |

θ_{adv} H₂O = advancing water contact angle, θ_{rec} H₂O = receding water contact angle, θₛₜₐ HD = static hexadecane contact angle, θ_{adv} HD = advancing hexadecane contact angle, θ_{rec} HD = receding hexadecane contact angle, NM = Not measurable due to drop pinning.

1. A vehicle sensor system comprising
an exterior surface, and
a multilayer film comprising a polymeric film on the exterior surface, wherein the polymeric film has a first surface opposite the exterior surface, and the first surface is hydrophobic.

2. (canceled)

3. The sensor system of claim 1, wherein the multilayer film comprises an adhesive layer.

4. The sensor system of claim 1, wherein the sensor system comprises a camera.

5. The sensor system of claim 1, wherein the exterior surface is a windshield surface.

6. (canceled)

7. The sensor system of claim 1, wherein the hydrophobic surface has an advancing water contact angle of greater than 130°.

8. The sensor system of claim 1, wherein the hydrophobic surface has a contact angle hysteresis of less than 15°.

9. The sensor system of claim 1, wherein the polymeric film has a haze of less than 7 percent and a transmittance of greater than 90%.

10. The sensor system of claim 1, wherein the polymeric film is a polyurethane.

11. A vehicle sensor system comprising
an exterior surface, and
a polymeric film on the exterior surface, wherein the polymeric film has a first surface opposite the exterior surface, and the first surface is hydrophilic

12. The sensor system of claim 11 comprising a multilayer film comprising the polymeric film.

13. The sensor system of claim 12, wherein the multilayer film comprises an adhesive layer.

14. The sensor system of claim 11, wherein the sensor system comprises a camera.

15. The sensor system of claim 11, wherein the exterior surface is a windshield surface.

16. (canceled)

17. The sensor system of claim 11, wherein the hydrophilic surface has an advancing water contact angle of less than 10°.

18. The sensor system of claim 11, wherein the polymeric film has a haze of less than 7 percent and a transmittance of greater than 90%.

19. The sensor system of claim 11, wherein the polymeric film is a polyurethane.

20. A film comprising:
a polymeric layer having a hydrophobic nanostructured surface,
wherein the surface comprises a silica-containing layer and a layer comprising a fluorinated molecule, and
wherein the nanostructured surface has an advancing hexadecane contact angle of greater than 80°.

21. The film of claim 20 wherein the nanostructured surface has an advancing hexadecane contact angle of greater than 100°.

22. A sensor system comprising a sensor, an exterior surface and the film of claim 20 on the exterior surface.

23. A film comprising:
a polymeric layer having a hydrophobic nanostructured surface,
wherein the surface comprises a hydrophobically-modified silica-containing layer.
